(19) United States
(12) Patent Application Publication
(10) Pub. No.: US 2007/0122558 A1
(43) Pub. Date: May 31, 2007

(54) Wood-treatment method comprising in situ polymerization under electromagnetic radiation

(75) Inventors: Vincent Gibiat, Toulouse (FR); Jerome Selmer, Paris (FR); Jean-Louis Halary, Paris (FR)

Correspondence Address: SUGHRUE MION, PLLC, 2100 PENNSYLVANIA AVENUE, N.W., SUITE 800, WASHINGTON, DC, 20037, US

(73) Assignee: HENRI SELMER PARIS

(21) Appl. No.: 10/582,639

(22) PCT Filed: Dec. 1, 2004
(86) PCT No.: PCT/FR04/03080

§ 371 Date: Jun. 12, 2006

(30) Foreign Application Priority Data
Dec. 10, 2003 (FR) 0314470
Jul. 20, 2004 (FR) 0408034

(51) Int. Cl. B05D 3/02; B29C 71/02; C08F 2/46

(52) U.S. Cl. 427/393; 427/397; 427/532; 427/487

(57) ABSTRACT

The invention relates to a wood-treatment method comprising in situ polymerisation under electromagnetic radiation. The inventive method comprises the following steps, namely: a first step consisting in impregnating a piece of wood with organic monomers that are selected from among (A) drying oils and/or (B) at least one first reactant comprising at least two glycidyl functions and at least one second reactant comprising at least two primary amine or secondary amine —NH functions, the average functionality of all of the first and second reactants being strictly greater than 2; and a second step consisting in exposing the wood thus impregnated to electromagnetic radiation having a wavelength (λ) of between 1 and 10⁻³ metres over a total time of between 5 and 40 seconds and with a power of between 300 and 1000 Watts. The invention also relates to a piece which is made from wood-resin composite material and which can be produced using the above method and to the use of one such piece for the production of all or part of wind instruments, particularly clarinets, for marquetry, forjoinery and for the construction of buildings and, in particular, roof frames.

The present invention relates to a method for treating wood by impregnation and in situ polymerization of monomers under electromagnetic radiation.

Hardwood species such as oak, ebony, boxwood and rosewood have always been highly sought by craftsmen and industrialists for their excellent mechanical properties, notably their large impact resistance, their capability of supporting significant loads, their low deformation over time or even their excellent acoustic properties. Now, these hard species generally grow slowly and consequently it is difficult to meet the demand of industries and craftsmen which transform wood.

Certain species have even become so rare that it proved to be necessary to protect them and to limit their felling. Thus, ebony and exotic wood used for centuries for making furniture, decorative objects and musical instruments, is today threatened with bans on felling and exporting it and there is a risk of its being no longer available on the market in a relatively close future.

Accordingly, the particular problem of replacing this precious species with other unprotected species is posed and more generally, the problem of improving mechanical properties of soft and/or fast-growing porous woods in order to be able to substitute them for the relatively more expensive slow-growing hard species.

The applicant, within the scope of her investigations aiming at finding a solution for replacing ebony in the making of wind instruments, discovered that it was possible, by means of a relatively simple method of in situ polymerization of polycondensable monomers or polymerizable by oxidization, to treat wood species, in particular those having a structure with open porosity, so as to considerably improve their mechanical and acoustic properties and to thereby dramatically extend the possibilities of applying these woods.

A method for treating woods by in situ polymerization and cross-linking of vinyl monomers is already known from the international application WO 01/53050. This method comprises radical polymerization, initiated by at least three different initiators, of a mixture of mono-functional vinyl monomers in the presence of divinyl cross-linking agents and at least one oil or one wax, the latter playing the role of polymerization moderator and of water-proofing agent for the finished product. Such a wood-treatment method, in particular when it is applied to the making of musical instruments, however has a major drawback, i.e., the presence of smelly residual monomers representing a certain risk for health. The problem of residual monomers was solved in the present invention by selecting a polymerization method different from radical polymerization, i.e., polycondensation or oxidative polymerization. In a mixture of polycondensable monomers or polymerizable by oxidization, each monomer is basically capable of reacting, without being activated, with the whole or a significant fraction of the present co-monomers, this is not the case for radical polymerization where the monomers can only react and be incorporated into the macro-molecular chain when they come into contact with the active (radical or ionic) centre of a growing polymeric chain. Now, these active centres are relatively not very numerous with respect to the number of monomers and generally unstable so that at the end of the polymerization, the proportion of monomers which have not reacted remains significant. In the case of polycondensation or oxidative polymerization, on the contrary, the probability for a monomer to react with one or more other monomers is very large and the fraction of monomers which have not reacted becomes rapidly insignificant.

The object of the present invention is therefore a method for treating wood by in situ polymerization, comprising:
a first step for impregnating a wooden part with organic monomers selected from

(A) drying oils and/or

(B) at least one first reactant including at least two glycidyl functions and at least one second reactant including at least two primary amine or secondary amine —NH functions, the average functionality of the whole of the first and second reactants being strictly greater than 2,
a second step for exposing the thereby impregnated wood to electromagnetic radiation with a wavelength (λ) between 1 and 10⁻³ meters for a total time between 5 seconds and 40 seconds and with a power between 300 and 1,000 Watts.

The object of the invention is further a part in wood/resin composite material capable of being made according to the above treatment method. This part preferably is a blank with the shape of a hollow cylinder suitable for making wind instruments.

Finally the object of the invention is the use of one such part for making the whole or a part of wind instruments such as clarinets, for marquetry, for joinery, for constructing buildings and in particular frameworks.

The method of the present invention may be applied with woods having open porosity, i.e., woods having an extended system of pores which communicate with each other, but also with not very porous woods such as ebony or woods including a majority of closed pores or cells. In both of these latter types of wood, hereafter called “wood with closed porosity”, communication between the relatively fewer open pores is more difficult and the impregnation rate, i.e., the increase in weight by impregnation, on the basis of the initial weight, will be lower.

More specifically, “wood with open porosity” in the present invention means wood capable of absorbing at 5° C., under normal pressure conditions and for an immersion period of 30 days, at least 15% by weight of 1-methoxy-2-propanol (reference solvent).

In an analogous way, “woods with closed porosity” under the same conditions absorb less than 15% by weight of 1-methoxy-2-propanol. Both of these types of wood however have an accessible pore volume without which no impregnation is possible. This accessible pore volume is simply larger for open porosity woods than for closed porosity woods.

As examples of open porosity woods, lime tree, spruce, monpani, poplar and wenge (Milletia laurentii), also called “Congo rosewood” may be mentioned. The latter is a relatively hard exotic wood close to ebony which is characterized by fast growing and therefore is an interesting candidate for replacing the latter. Its main drawback lies in its large porosity, a defect for which the present invention proposes a remedy.

The closed porosity woods are for example selected from ebonies and rosewoods, preferably from ebonies.

The first impregnation step of the treatment method according to the invention is preferably performed under a larger pressure than the atmospheric pressure, and in particular at a pressure between 0.4 and 1 MPa (4 and 10 bars). This high pressure is particularly useful for increasing the impregnation rate when the viscosity of the impregnation liquid is high, either because of a high concentration of monomers or because of a low impregnation temperature.

The second step for heating the impregnated wooden part by exposing it to electromagnetic radiation is essential for the method according to the invention. Indeed, heating with electromagnetic radiation, notably with microwaves, provides fast heating up to the core of the part, in other words, over the totality of the impregnation depth and thereby guarantees a reaction as complete as possible of the monomers.

The heat energy required for complete polymerization of course depends on the size of the part. For polymerization of drying oils (A), the heat energy to be provided is approximately proportional to the volume of the part. Polycondensation of amines and epoxides (B) is however an exothermic reaction and it generally is sufficient to heat the wooden part to a sufficient temperature and for a sufficient time in order to allow self-sustainment of the polycondensation exothermic reaction between the first and second reactants by the released reaction heat.

The wavelength of the electromagnetic radiation is preferably between 10⁻¹ and 10⁻² meters and the time of exposure to electromagnetic radiation is between 15 and 30 seconds.

Some woods resist less well than others to extended powerful heating and risk being subject to damages. It may then be of interest to split the electromagnetic radiation exposure step into several periods of shorter duration, generally not exceeding 10 to 15 seconds. These periods are generally separated by periods without any heating, from a duration of a few minutes to several tens of minutes, letting the wood cool down at least partially.

Exposure to electromagnetic radiation may be applied in an ordinary microwave oven with a power output at least equal to 300 Watts, preferably between 400 and 1,000 Watts.

In a first preferred embodiment of the inventive method, the wood to be treated is an open porosity wood and the monomers are selected from (B) type monomers after polycondensation resulting in the formation of epoxy-amine resins. These monomers (B) should be used in solution in a volatile organic solvent which will normally be removed after impregnation. Such a method comprises

(a) immerging a part in open porosity wood in a solution containing, in a volatile organic solvent, at least one first reactant including at least two glycidyl functions and at least one second reactant including at least two primary amine or secondary amine —NH functions, the average functionality of the whole of the first and second reactants being strictly greater than 2, for sufficient time so as to allow at least 60% of the accessible pore volume of the wood to be filled with the solution, and at a sufficiently low temperature for preventing too early polymerization of the monomers during this impregnation step (a),

(b) removing the part impregnated with the organic solution and draining and/or wiping the wooden part,

(c) exposing the thereby impregnated wood to electromagnetic radiation with a wavelength (λ) between 1 and 10⁻³ meters for a total time between 5 seconds and 40 seconds, and optionally,

(d) drying the part, preferably under reduced pressure, for sufficient time to allow evaporation of the organic solvent.

This preferred embodiment of the method for treating porous wood of the present invention considerably improves the mechanical properties of the treated woods. The latter have a significantly larger Young modulus than non-treated wood, and reduced brittleness and perfectly withstand cracking over time.

Moreover, the method of the invention has the advantage of not changing the dimensions of the wooden part. The applicant has actually noticed that the dimensions of the treated parts remain unchanged at least up to a polymer/wood weight ratio equal to 0.5. With this large dimensional stability, parts with definitive dimensions may thereby be treated.

It is also possible to machine the treated parts according to the method of the present invention. Thus, in a preferred embodiment of the invention, i.e., the making of wind instruments, blanks having the shape of a hollow cylinder may be treated and the perforations may be made subsequently.

The treated woods further have a very low tendency of absorbing air moisture or water coming into contact with the treated part.

In the first step of this embodiment, the wooden part to be treated is soaked by immersion in a solution containing polymerizable reactants in a relatively volatile organic solvent. This solvent preferably has a melting point less than or equal to −30° C. and a boiling point less than or equal to 250° C., and more particularly less than or equal to 150° C. The volatility of the organic solvent is indeed important in order to allow easy drying of the part once the polycondensation reaction is completed. The volatile organic solvent is preferably selected from hydrocarbon compounds with a C₁₋₆ backbone and including at least one polar group selected from secondary alcohol, ether and ester functions.

Another preferred group of solvents for applying the present invention is formed by vegetable oils, some of which are already used for treating wood. The vegetable oil used should have a low viscosity at low temperature in order to be able to penetrate with a reasonable rate inside the porous system of the wood at temperatures which do not trigger too early spontaneous polymerization of the system.

The skilled practitioner will of course see to that the organic solvent(s) is (are) selected so that it (they) do(es) not interfere with the polycondensation reaction of the polymerizable reactants, and one should make sure in particular that compounds with labile hydrogen compounds are not used, such as primary alcohols, phenols, and thiols, capable of reacting with the glycidyl functions of the first reactant.

Examples of preferred organic solvents may be mentioned such as, ethylene glycol dimethyl ether, di-ethylene glycol dimethyl ether, glycerol 1,3-diacetate, triacetin and 1-methoxy-2-propanol as mentioned earlier, the latter being particularly preferred.

As examples of vegetable oils, linseed oil, castor oil, sunflower oil, soya bean oil, walnut oil, grape seed oil may be mentioned. In particular linseed oil is preferred. Indeed, linseed oil belongs to the drying oils (=(A) monomers). In the impregnation step (a), it will therefore play the role of solvent for the (B) monomers and will polymerize during step (c) at the same time as the (B) monomers.

Impregnation of the wood should be performed for sufficient time to allow at least 60% of the accessible pore volume of the wood to be filled with the solution. The total accessible pore volume of a given wood may easily be determined by letting the impregnation continue until the weight of a sample no longer increases with the impregnation time. The accessible pore volume of the sample is equal to the quotient of the weight difference between the impregnated sample and the non-impregnated sample over the specific gravity of the impregnation solution. This accessible pore volume may of course be based on a unitary volume of the wood to be treated.

The polycondensation reaction used in this embodiment of the method according to the invention, is a reaction between a first reactant including at least two glycidyl (epoxide) groups and a second reactant including at least two primary amine or secondary amine —NH functions, capable of reacting with the glycidyl groups of the first reactant. It is well known in the field of polycondensation that when di-functional reactants are used exclusively, i.e., reactants including exactly two reactive functions (epoxides or NH), the obtained macromolecular system will exclusively consist of linear chains but will not form a cross-linked three-dimensional network as intended in the present invention. It is therefore indispensable to use a certain fraction of reactants including more than two reactive functions (epoxide or —NH). The proportion of polyfunctional molecules is generally expressed by the average functionality of the reactive system, i.e., the average number of reactive functions per molecule, which should be strictly greater than 2 in order to obtain a cross-linked three-dimensional system. In connection with this, it should be noted that in the polycondensation system used in the present invention, the functionality of a primary or secondary amine is not equal to the number of amine functions but to the number of —NH functions. A primary mono-amine including a single —NH₂ function may react twice with an epoxy function and therefore has functionality equal to 2. Similarly, a primary di-amine has a functionality of 4.

A parameter with which the cross-linking level of a polymer system of epoxy-amine resins may be expressed, is the cross-linking density, i.e., the number of moles of cross-linking points per unit mass of the network. The theoretical cross-linking density, i.e., the maximum cross-linking density, corresponding to the maximum degree of polymerization of the system, may easily be calculated from theoretical equations using the functionality and the molecular mass of the different reactants. Such equations applicable to stoichiometric systems or non-stoichiometric systems have been proposed (see for example the article of Jean Louis Halary et al. in Polymery 1997, 42, No.2, pages 86- 95). In a highly reactive polycondensation system such as that of the epoxy-amine resins used in the present invention, it may be assumed that the actual cross-linking density is only very slightly less than the theoretical cross-linking density. The applicant noticed that she obtained satisfactory results as regards the mechanical and acoustic properties of the treated woods when the actual cross-linking density was at least equal to 0.1 mol/kg, preferably between 0.5 and 5 mols/kg.

As examples of first reactants including at least two glycidyl functions, 1,4-butanediol, diglycidyl ether, 1,6-hexanediol diglycidyl ether, resorcinol diglycidyl ether, neopentylglycol diglycidyl ether, trimethylol propane polyglycidyl ether, hexahydroxyphtalic acid diglycidyl ester, bisphenol A diglycidyl ether, glycidyl ethers of polyalkylene glycols, such as diethylene glycol diglycidyl ether, triethylene glycol diglycidyl ether, polyethylene glycol diglycidyl ether or polypropylene glycol diglycidyl ether, glycerol polyglycidyl ether, diglycerol polyglycidyl ether or polyglycerol polyglycidyl ether, sorbitol polyglycidyl ether may be mentioned.

Among the latter, in particular the use of bisphenol A diglycidyl ether and 1,4-butanediol diglycidyl ether is preferred.

Compounds including at least two primary or secondary amine −H functions, capable of reacting with the glycidyl functions of the first reactant, for example are ethylenediamine, diethylenetriamine, tetraethylenepentamine, aminoethylpiperazine, benzyldimethyla mi ne, piperidine, 2-methylpentamethylenediamine, diaminodiphenylmethane, diaminodiphenylsulfone, 1,3-pentanediamine, hexamethylenediamine, bis(hexamethylene)-triamine, 1,2-diaminocyclohexane, 4-benzylaniline, N,N′-dimethyldiaminodiphenylmethane, hexylamine and N,N′-dimethyl-hexamethylenediamine. Among these amines, diaminodiphenylmethane, diaminodiphenylsulfone, hexamethylenediamine, hexylamine and N,N′-dimethylhexamethylenediamine are preferably used.

The first and second reactants are preferably used in molar concentrations so that the stoichiometric ratio of the number of glycidyl functions to the number of amine and/or phenol functions does not deviate too much from 1 and preferably is between 0.5 and 2. Outside this range, the degree of polymerization remains insufficient for forming a cross-linked three-dimensional network. On the other hand, within this range, the applicant noticed that it was possible to vary as desired the glass transition temperature of the obtained polymer system by operating on the stoichiometric ratio of the reactants in presence. Thus, for a given combination of reactants, the glass transition temperature is generally maximum for a stoichiometric ratio equal to 1 and is reduced when the stoichiometric ratio deviates from this value (see also the aforementioned article).

The impregnation solution used in step (a) of the method for treating wood by polycondensation should have sufficient polymerisable reactant content so as to allow a three-dimensional polymer network to be formed inside the pores of the treated wood, without having excessive viscosity which may interfere with the penetration of the solution into the pore volume of the wood to be treated. The applicant noticed that satisfactory results were generally obtained by using impregnation solutions having a total polymerizable monomer (B) content between 10 and 60% by weight, preferably between 10 and 30% by weight.

With the method described above, open porosity wood may be strengthened by a cross-linked polymer resin and the mechanical and acoustic properties of this wood may thereby be changed. By suitably selecting the reactants, the cross-linking density and the stoichiometry of the reactive system, the value of the glass transition temperature (Tg) of the polymerized resin may be relatively freely adjusted within a large range, between −40° C. and 250° C., for example. The glass transition temperature may for example be determined by differential scanning calorimetric analysis (DSC) or by dynamic mechanical analysis (DMA). The glass transition temperature of the resin will be adjusted according to the mechanical properties which are desirably imparted to the final composite material. Thus, in the field of musical instruments, it is often of interest to increase the resonance capability of the woods and the glass transition temperature will then preferably be adjusted to a larger value by at least 10 degrees than the temperature of use of the instrument, for example at a value at least equal to 40° C. On the contrary, when it is desired to obtain relatively “soft” treated woods from the acoustic point of view, in other words low resonance woods, capable of absorbing sounds, the glass transition temperature of the resin will preferably be adjusted at a value substantially less than room temperature, for example to a value less than 0° C.

The influence of the value of the glass transition temperature on the mechanical properties of resins, such as hardness, impact strength, stiffness or elasticity is known and mechanical properties of wood/epoxy resin composites may thus be adjusted similarly, by a certain number of simple polymerization tests.

In an alternative method for treating wood by polycondensation of epoxy amine resins, the impregnation solution used in step (a) contains, in addition to in situ polymerizable reactant, one or more mineral fillers or pigments. The particles of these additives, in order to be able to easily penetrate with the impregnation solution inside the porous structure, should have a very fine grain size. The applicant noticed that the distribution of the filler or pigment particles in the treated wood was generally satisfactory when they had an average size less than or equal to 200 nm, preferably between 10 nm and 150 nm.

As examples of such fillers or pigments, nanosilica, titanium dioxide or clay may be mentioned.

Of course the impregnation solution may contain other additives currently used in treating wood such as fungicidal, insecticidal agents or even soluble dyes.

The monomers (B) applied in the in situ polycondensation reaction are generally characterized by significant reactivity. This is why it is often necessary to apply the impregnation step (a) at a temperature less than room temperature in order to prevent undesirable too early polymerization of the reactants. Such an early polymerization will actually be expressed by blocking of the pores at the surface layers of the wood and would thereby prevent satisfactory penetration of the solution towards the deeper layers. The impregnation of the wooden part with the organic solution in step (a) is therefore performed preferably at a temperature less than 20° C., in particular less than 10° C. and ideally at a temperature close to 5° C.

The duration of the impregnation step depends on a certain number of factors such as the viscosity of the impregnation solution, the impregnation temperature, the size of the pores and of the apertures between the pores or even the desired penetration depth. Tests conducted by the applicant have shown that the duration of the impregnation step (a) is preferably at least equal to 5 days, preferably between 10 and 30 days. These relatively long durations are required because the significant viscosity of the solution at low temperature. Of course, the penetration of the impregnation solution into the wood may be accelerated by performing this step under pressure, for example under a pressure from 0.4 to 1 MPa (4 to 10 bars).

A second embodiment of the method according to the invention does not use polycondensation of glycidyl and amino reactants but polymerization/oxidization of drying oils. The polymerization of oils including a significant proportion of chains of polyunsaturated fatty acids, such as linolenic acid (3 double bonds) and linoleic acid (2 double bonds), is known and utilized for a long time i.a. in the field of painting where the capability of a paint to dry (polymerize) rapidly is called “siccativity”. Polymerization of drying oils is a reaction with opening of the double bonds in the presence of oxygen and formation of bonds between different fatty chains. Acceleration of the drying (the polymerization reaction) by heating and/or adding dry agents, generally powdered metal oxides, is also known.

This second embodiment of the method according to the invention therefore comprises

(a) immerging a wooden part in a drying oil or a mixture of drying oils for sufficient time in order to allow at least 60% of the accessible pore volume of the wood to be filled with the oil, and at a sufficiently low temperature to prevent too early polymerization of the oil during this impregnation step (a),

(b) removing the part impregnated with the drying oil and draining and/or wiping of the wooden part,

(c) exposing the thereby impregnated wood to electromagnetic radiation with a wavelength (λ) between 1 and 10⁻³ meters for a total time between 5 seconds and 40 seconds and with a power between 300 and 1,000 Watts.

Although polymerization under electromagnetic radiation of drying oils may basically be applied to any wood, i.e., both “open” porosity woods and “closed” porosity woods, it proves to be particularly interesting for treating closed porosity woods which have a small accessible pore volume. Indeed, polymerization of drying oils alone does not generally result in a sufficient polymer network in order to impart to an open porosity wood, mechanical properties comparable with those of dense wood such as ebony. The second embodiment is therefore not only a method for making wood/resins composite material intended to replace precious woods such as ebony, but a method intended to improve the mechanical properties, and in particular the acoustic properties of such woods.

Indeed the applicant was surprised in noticing that a clarinet provided with an ebony barrel treated according to the second embodiment of the method had an improved gain in acute harmonics with which the projection capacity (=long distance sound transmission) of the instrument may be increased considerably. This barrel may be blindly identified (blind test) among a large number of barrels having undergone known treatments.

Another advantage of the thereby treated woods lies in that they are less likely to crack within the scope of their making (machining) and/or use. The woods are further less sensitive to changes in environmental conditions (hygrometry, temperature).

The wood species preferably used for this second embodiment are therefore selected from ebonies and rosewoods, woods currently used for making musical instruments, in particular wind musical instruments.

The drying oils are considerably less reactive than the glycidyl and amino reactants (B monomers) and generally there is no risk of polymerizing the drying oils during the impregnation step. It is therefore not necessary to apply this step at low temperature and it is preferred that the wood to be treated is impregnated at a temperature between room temperature and 80° C. and at a pressure larger than atmospheric pressure. Under these temperature and pressure conditions, the duration of the impregnation step is preferably between 6 and 48 hours, in particular between 6 and 24 hours. Heating the impregnation liquid is particularly useful in this embodiment applied to closed porosity woods as it reduces the viscosity of the oil and so the time required for filling at least 60% of the accessible pore volume.

The drying oils which may be used in the method of the present invention are known and generally include linseed oil, castor oil, oil from aleurites, oiticica oil, isano oil, isomerized linseed oil and dehydrated castor oil. Oil from aleurites, oiticica oil and isano oil are driing oils naturally comprising a substantial fraction of chains of fatty acids with particularly reactive conjugate double bonds. Isomerized linseed oil and dehydrated castor oil are oils which have undergone treatment in order to increase the level of fatty acids with conjugate double bonds.

The drying oil may be used in combination with a small fraction of so-called “semi-drying” oils. These oils, also known in the art, have insaturation levels less than those of drying oils but they are however capable of forming by polymerization continuous more or less hard films. These semi-drying oils for example include cameline oil, safflower oil, hempseed oil, pumpkin oil, melon oil, niger seed oil, walnut oil, poppy seed oil, perilla oil, grape seed oil, sesame oil, soya bean oil, tabacco oil, and sunflower oil. The drying oil may be used in particular with 0.1 to 0.5 parts by weight of one or more of these semi-drying oils.

The drying and semi-drying oils above naturally contain a small proportion of free fatty acids resulting from partial hydrolysis of glycerides. It may be interesting to add an additional amount of free fatty acids. These fatty acids, perfectly compatible with the oils, have the advantage of increasing the hydrophilicity of the oils and may thereby facilitate wetting of the wood and facilitate penetration of the oils inside the latter.

The drying oil will be used preferably as a mixture with 0.05 to 0.2 parts by weight of mixture of linseed oil or castor oil fatty acids.

Diluting the drying oil may further be useful, optionally as a mixture with one or more semi-drying oils and/or with unsaturated fatty acids, with one or more volatile organic solvents miscible with the oily phase in order to reduce the viscosity of the impregnation liquid. These solvents include those mentioned earlier for the first preferred embodiment of the invention, but in the absence of glycidyl/amino reactants, it is of course not necessary to select them from aprotic solvents.

The addition of one or more agents promoting the polymerization reaction to the drying oils may also be contemplated. These promoting agents may be oxidizers or even free radical generators.

In a preferred embodiment of the present invention, the method for treating wood by in situ polymerization is applied to the making of parts of wind instruments, notably clarinets, such as beak mouthpieces, barrels, bodies and bells. The wooden part advantageously is then a blank with the shape of a hollow cylinder, suitable for making wind instruments.

Another interesting application of the method for treating wood of the present invention is restoration or preservation of ancient woods, notably of ancient furniture or ancient musical instruments, the structure of which has been embrittled over time by environmental effects such as water, excessive temperatures or even xylophagous insects. The use of the method for treating wood by in situ polycondensation for restoration and/or preservation of ancient woods therefore is another object of the present invention.

Finally, the applicant noticed that by applying the method of the present invention to undried or partially dried woods, it is possible to reduce or prevent occurrence of slits during subsequent aging of the wood. Thus it becomes possible to reduce or even suppress without any drawbacks the drying time in the small-scale or industrial wood transformation process. Accordingly, the object of the present invention also is the use of the method for treating wood as described above, for reducing or even suppressing the natural and/or artificial wood drying step before machining.

1. A wood-treatment method by in situ polymerization, comprising:
a first step for impregnating a wooden part with organic monomers selected from
(A) drying oils and/or
(B) at least one first reactant including at least two glycidyl functions and at least one second reactant including at least two primary amine or secondary amine —NH functions, the average functionality of the whole of the first and second reactants being strictly greater than 2,
a second step for exposing the thereby impregnated wood to electromagnetic radiation with a wavelength (λ) between 1 and 10⁻³ meters for a total period between 5 seconds and 40 seconds and with a power between 300 and 1,000 Watts.

2. The wood-treatment method according to claim 1, characterized by the fact that the step for impregnating the wood with organic monomers is performed under a pressure of 0.4 to 1 MPa.

3. The wood-treatment method according to claim 1 to 2, characterized by the fact that the electromagnetic radiation has a wavelength between 10⁻¹ and 10⁻² meters.

4. The wood-treatment method according to any of the preceding claims, characterized by the fact that the exposure time to electromagnetic radiation is between 15 and 30 seconds.

5. The wood-treatment method according to any of the preceding claims, characterized by the fact that the exposure to electromagnetic radiation is performed in several periods of shorter duration, separated by periods for cooling the wood.

6. The wood-treatment method according to any of the preceding claims, characterized by the fact that the exposure to electromagnetic radiation is performed in a microwave oven with a power output at least equal to 300 Watts, preferably between 400 and 1,000 Watts.

7. The wood-treatment method according to any of the preceding claims, characterized by the fact that the wooden part is a blank having the shape of a hollow cylinder suitable for making wind instruments.

8. The wood-treatment method by in situ polymerization according to any of the preceding claims, characterized by the fact that it comprises:
(a) immerging a part in open porosity wood in a solution containing, in a volatile organic solvent, at least one first reactant including at least two glycidyl functions and at least one second reactant including at least two primary amine or secondary amine —NH functions, the average functionality of the whole of the first and second reactants being strictly greater than 2, for sufficient time so as to allow at least 60% of the accessible pore volume of the wood to be filled with the solution, and at a sufficiently low temperature for preventing too early polymerization of the monomers during this impregnation step (a),
(b) removing the part impregnated with the organic solution and draining and/or wiping the wooden part,
(c) exposing the thereby impregnated wood to electromagnetic radiation with a wavelength (λ) between 1 and 10⁻³ meters for a total time between 5 seconds and 40 seconds and with a power between 300 and 1,000 Watts and optionally,
(d) drying the part, preferably under reduced pressure, for sufficient time to allow evaporation of the organic solvent.

9. The wood-treatment method according to claim 8, characterized by the fact that the open porosity wood used is wenge (Milletia laurentii), lime tree, spruce, monpani, or poplar, preferably wenge.

10. The wood-treatment method according to claim 8 or 9, characterized by the fact that the first reactant including at least two glycidyl functions is selected from 1,4-butanediol diglycidyl ether, 1,6-hexanediol diglycidyl ether, neopentylglycol diglycidyl ether, trimethylolpropane polyglycidyl ether, hexahydroxyphtalic acid diglycidyl ester, bisphenol A diglycidyl ether, diglycidyl ethers of polyalkyleneglycols such as diethyleneglycol diglycidyl ether, triethyleneglycol diglycidyl ether, polyethyleneglycol diglycidyl ether, or polypropyleneglycol diglycidyl ether, glycerol diglycidyl ether, diglycerol diglycidyl ether, or polyglycerol diglycidyl ether, sorbitol polyglycidyl ether.

11. The wood-treatment method according to any of claims 8 to 10, characterized by the fact that the second reactant including at least two amine functions is selected from ethylenediamine, diethylenetriamine, tetraethylenepentamine, aminoethylpiperazine, benzyldimethylamine, piperidine, 2-methylpentamethylenediamine, diaminodiphenylmethane, diaminodiphenylsulfone, 1,3-pentane-diamine, hexamethylenediamine, bis(hexamethylene)-triamine, 1,2-diaminocyclohexane, 4-benzylaniline, N,N′-dimethyldiamino-diphenylmethane, hexylamine and N,N′-dimethylhexamethylene-diamine.

12. The wood-treatment method according to any of claims 8 to 11, characterized by the fact that the volatile organic solvent used in step (a) has a melting point less than −30° C. and a boiling point less than 250° C., preferably less than 150° C.

13. The wood-treatment method according to claim 12, characterized by the fact that the volatile organic solvent is selected from hydrocarbon compounds with a C₁₋₆ backbone and including at least one polar group selected from secondary alcohol, ether and ester functions, and from vegetable oils.

14. The wood-treatment method according to claim 13, characterized by the fact that the volatile organic solvent is 1-methoxy-2-propanol.

15. The wood-treatment method according to any of claims 8 to 14, characterized by the fact that the impregnation of the wooden part with the organic solution in step (a) is performed at a temperature less than 20° C., preferably less than 10° C., and in particular at a temperature close to 5° C., and for a time at least equal to 5 days, preferably between 10 and 30 days.

16. The wood-treatment method according to any of claims 1 to 7, characterized by the fact that it comprises
(a) immerging a wooden part in a drying oil or a mixture of drying oils for sufficient time to allow at least 60% of the accessible pore volume of the wood to be filled with the oil, and at a sufficiently low temperature to prevent too early polymerization of the oil during this impregnation step (a),
(b) removing the part impregnated with the drying oil and draining and/or wiping the wooden part,
(c) exposing the thereby impregnated wood to electromagnetic radiation with a wavelength (λ) between 1 and 10⁻³ meters for a total time between 5 seconds and 40 seconds and with a power between 300 and 1,000 Watts.

17. The wood-treatment method according to claim 16, characterized by the fact that the impregnation step (a) is applied at a temperature between room temperature and 80° C. and for a time between 6 and 48 hours, preferably between 6 and 24 hours.

18. The wood-treatment method according to claim 16 or 17, characterized by the fact that the wood is selected from ebonies and rosewoods.

19. The wood-treatment method according to any of claims 16 to 18, characterized by the fact that the drying oil is selected from linseed oil, isomerized linseed oil, castor oil, dehydrated castor oil, oil from aleurites, oiticica oil and isano oil.

20. The wood-treatment method according to any of claims 16 to 19, characterized by the fact that the drying oil is used as a mixture with one or more semi-drying oils, preferably with 0.1 to 0.5 parts by weight of one or more semi-drying oils selected from cameline oil, safflower oil, hempseed oil, pumpkin oil, melon oil, niger seed oil, walnut oil, poppy seed oil, perilla oil, grape seed oil, sesame oil, soya beam oil, tobacco oil and sunflower oil.

21. The wood-treatment method according to any of claims 16 to 20, characterized by the fact that the drying oil is used as a mixture with unsaturated fatty acids, preferably with 0.05 to 0.2 parts by weight of a mixture of fatty acids of linseed oil or castor oil.

22. The wood-treatment method according to any of the preceding claims, characterized by the fact that the drying oil, optionally as a mixture with one or more semi-drying oils and/or with unsaturated fatty acids, is further diluted with one or more volatile organic solvents miscible with the oily phase.

23. The wood-treatment method according to any of claims 16 to 22, characterized by the fact that one or more promoters of the polymerization reaction are added to the drying oil.

24. A part in a wood/resin composite material capable of being made by the method according to any of the preceding claims.

25. The use of a part according to claim 24 for making the whole or part of wind instruments, in particular clarinets, for marquetry, for joinery, for the construction of buildings and in particular frameworks.

26. The use of the method according to any of claims 1 to 23 for restoration and/or preservation of ancient woods.

27. The use of the method according to any of claims 1 to 23 for reducing or even suppressing the step for natural and/or artificial drying of the wood before machining.
